(19) United States
(12) Patent Application Publication
(10) Pub. No.: US 2017/0328134 A1
(43) Pub. Date: Nov. 16, 2017

(54) System for Extended Use in High Temperature Wellbore

(71) Applicant: Baker Hughes Incorporated, Houston, TX (US)

(72) Inventors: Timothy Sampson, Tomball, TX (US); Gasmi Khaled, Houston, TX (US); Stephen Zuklic, Humble, TX (US); Jason McCann, Cypress, TX (US); William Harvey, Houston, TX (US); David Betancourt, Cypress, TX (US); Charles McClean, Spring, TX (US); Mark Sloan, Notom, UT (US)

(73) Assignee: Baker Hughes Incorporated, Houston, TX (US)

(21) Appl. No.: 15/594,247

(22) Filed: May 12, 2017

Related U.S. Application Data
(60) Provisional application No. 62/336,093, filed on May 13, 2016.

(51) Int. Cl. E21B 7/124; H01M 10/39; E21B 7/04; E21B 47/06; E21B 47/00; E21B 23/00

(52) U.S. Cl. CPC E21B 7/1245; E21B 7/046; E21B 47/065; H01M 10/39; E21B 23/00; B01J 2219/00051; E21B 47/00

(57) ABSTRACT

A method and system for downhole operations that includes an energetic material with a reduced sensitivity to temperature, and a temperature rating that is higher than other energetic materials. Downhole tools that use energetic material thus can have a higher temperature rating with the reduced sensitivity energetic material. One embodiment of the energetic material includes an energetic heterocycle compound, such as 2,6-diamino-3,5-dinitropyrazine-1-oxide.

### CROSS-REFERENCE TO RELATED APPLICATION

This application claims priority from U.S. Provisional Application Ser. No. 62/336,093, filed May 13, 2016, the full disclosure of which is incorporated by reference herein in its entirety and for all purposes.

### BACKGROUND OF THE INVENTION

### 1. Field of Invention

The present disclosure relates in general to wellbore operations. More specifically, the present disclosure relates to the use of a high explosive in a wellbore that is at an elevated temperature.

### 2. Description of Prior Art

High explosives are often used in many different downhole systems and operations. Some operations mechanically cleave objects downhole, which include perforating, severing tools, junk shots, and chemical cutters. Other applications of high explosives downhole actuate mechanical devices, such as to shift sleeves to open ports, release components, set packers, operate back-off tools, and pipe recovery applications. Perforating systems are used for the purpose, among others, of making hydraulic communication passages, called perforations, in wellbores drilled through earth formations so that predetermined zones of the earth formations can be hydraulically connected to the wellbore. Perforations are needed because wellbores are typically lined with a string of casing and cement is generally pumped into the annular space between the wellbore wall and the casing. Reasons for cementing the casing against the wellbore wall includes retaining the casing in the wellbore and hydraulically isolating various earth formations penetrated by the wellbore. Sometimes an inner casing string is included that is circumscribed by the casing. Without the perforations, oil/gas from the formation surrounding the wellbore cannot make its way to production tubing inserted into the wellbore within the casing.

Perforating systems typically include one or more perforating guns connected together in series to form a perforating gun string, which can sometimes surpass a thousand feet of perforating length. The gun strings are usually lowered into a wellbore on a wireline or tubing, where the individual perforating guns are generally coupled together by connector subs. Included with the perforating gun are shaped charges that typically include a housing, a liner, and a quantity of high explosive inserted between the liner and the housing. When the high explosive is detonated, the force of the detonation collapses the liner and ejects it from one end of the charge at very high velocity in a pattern called a jet that perforates the casing and the cement and creates a perforation that extends into the surrounding formation. Each shaped charge is typically attached to a detonation cord that runs axially within each of the guns.

### SUMMARY OF THE INVENTION

Disclosed herein is a method and system for perforating a wellbore with a perforating system having an energetic material. One example system for subterranean perforating includes a shaped charge having a case, a cavity in the case, and a liner disposed in the cavity. The system also includes a primer assembly disposed in a sidewall of the charge case, a detonation cord disposed adjacent the primer assembly, an energetic material in the shaped charge, the primer assembly, and the detonation cord, and that contains 2,6-diamino-3,5-dinitropyrazine-1-oxide, and a metal jacket encasing the detonation cord. The system optionally further includes perforating gun bodies that each house additional shaped charges, and booster assemblies within the gun bodies that each include an energetic material having 2,6-diamino-3,5-dinitropyrazine-1-oxide. In an example, the detonation cord, shaped charge, and primer assembly are detonatable after being disposed at a high temperature for an extended period of time. The system can further include a detonator coupled with the detonation cord and in communication with a source of electricity, wherein the detonator includes 6-diamino-3,5-dinitropyrazine-1-oxide. In this example, the 6-diamino-3,5-dinitropyrazine-1-oxide is a secondary explosive, and the detonator further contains a primary explosive that includes silver azide.

Also disclosed herein is a method of wellbore operations, which includes conducting operations within a wellbore using a perforating system having, a shaped charge, a detonation cord, and a pyrazine compound disposed in the shaped charge and detonation cord. The system also includes initiating detonation of the pyrazine compound in the detonation cord that in turn initiates detonation of the pyrazine compound in the shaped charge. In one example the pyrazine compound contains 6-diamino-3,5-dinitropyrazine-1-oxide. The method can further include deploying the perforating system within a portion of the wellbore that is at a high temperature and for an extended period of time prior to initiating detonation of the pyrazine compound in the detonation cord. In this example, energy is released from the pyrazine compound during detonation that is at an amount which is substantially the same as energy being released when the pyrazine compound is detonated at a normal operating temperature. In an alternative of the method, the detonation cord includes a metal jacket.

Another system for subterranean perforating disclosed herein includes a shaped charge, a detonation cord disposed adjacent the shaped charge, and an energetic material in the detonation cord, and that includes an energetic heterocycle compound. The energetic heterocycle compound can be a pyrazine compound, or a 2,6-diamino-3,5-dinitropyrazine-1-oxide. In an embodiment, the shaped charge includes a charge case with a cavity, a liner in the cavity, and wherein the energetic heterocycle compound is disposed in the cavity between the charge case and the liner. The shaped charge of this system can further include a booster in the charge case, and wherein an amount of the energetic heterocycle compound is disposed in the booster.

### BRIEF DESCRIPTION OF DRAWINGS

Some of the features and benefits of the present invention having been stated, others will become apparent as the description proceeds when taken in conjunction with the accompanying drawings, in which:

FIG. 1 is a partial side sectional view of an example of a perforating system for use in a wellbore.

FIG. 2 is a side sectional view of an example of a perforating gun for use in the perforating system of FIG. 1.

FIG. 3 is a partial side sectional view of an example of an alternate example of a perforating system for use in a wellbore.

FIG. 4A is a side sectional view of an example of a shaped charge for use with the perforating systems of FIGS. 1 and 3.

FIGS. 4B and 4C are side sectional views of an example of stages of detonation of the shaped charge of FIG. 4A.

FIG. 5 is a side sectional view of an example of a booster system for transferring charges between adjacent perforating guns in a perforating string.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of the cited magnitude. In an embodiment, usage of the term “substantially” includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

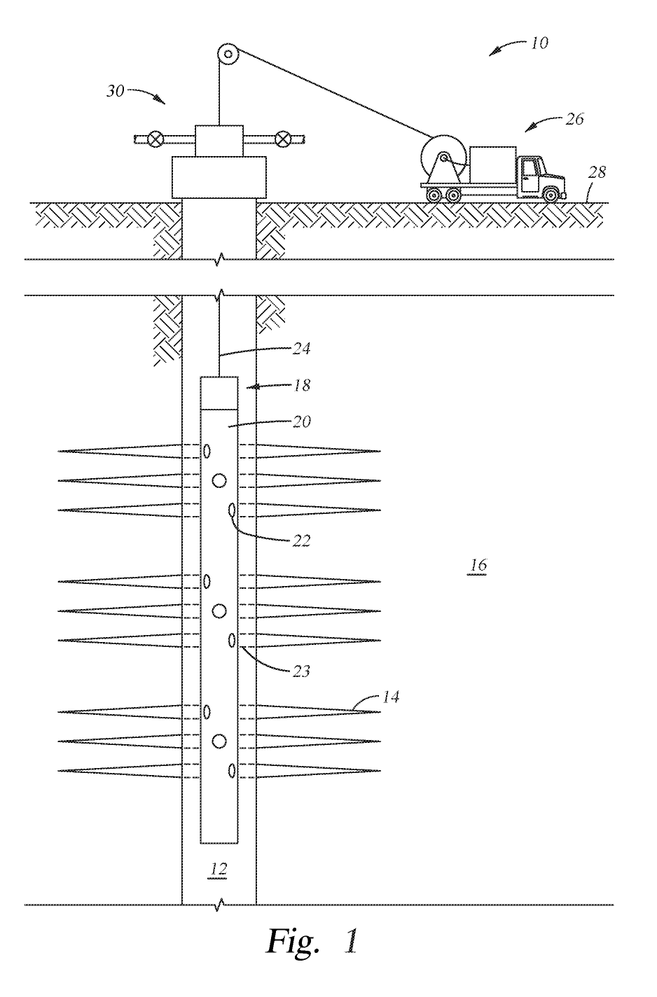

Shown in a side partial sectional view in FIG. 1 is an example of a perforating system 10 disposed in a wellbore 12. In the illustrated example, the perforating system 10 is being used to create perforations 14 in a formation 16 that surrounds the wellbore 12. The perforating system 10 shown includes a perforating string 18 which is made up of a series of perforating guns 20 that are connected in series. Example shaped charges 22 are illustrated disposed within each of the guns 20, and which when detonated form jets 23 that project radially outward from the perforating guns 20 to form the perforations 14. Signals and/or power for initiating the detonation of the shaped charges 22 can be provided via a wireline 24 shown attached to an upper end of the perforating string 18.

An end of the wireline 24 distal from the perforating string 18 is shown extending into a service truck 26 on surface 28 and outside of the wellbore 12. A reel (not shown) can be provide in the truck 26 for spooling wireline 24 in and out of the wellbore 12. An example of a wellhead assembly 30 is shown mounted over the opening of the wellbore 12, and through which the wireline 24 is inserted. Embodiments also exist where in addition to providing electricity downhole, the wireline 24 provides a way for signals to be transmitted between surface 28 and downhole, and/or a deployment means for raising and lowering the perforating string 18 within wellbore 12.

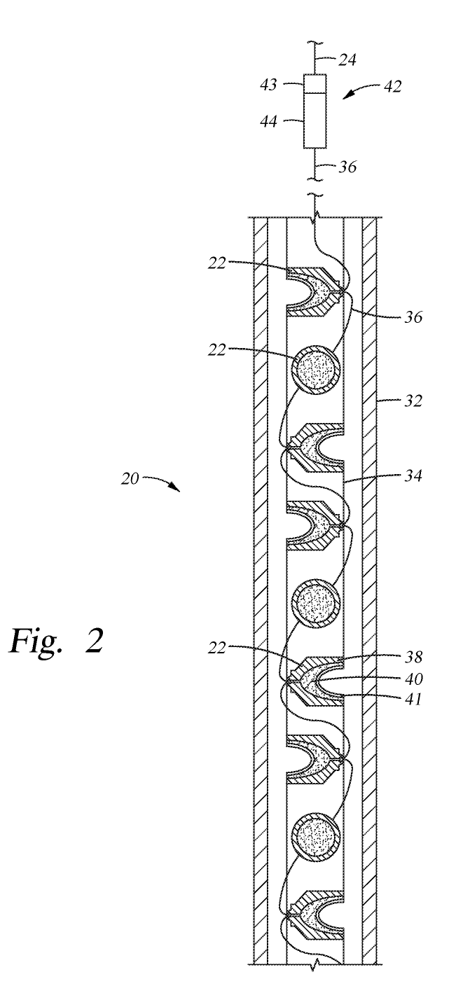

An example of a perforating gun 20 is shown in side sectional view in FIG. 2. In this embodiment, an outer portion of the gun 20 includes an annular gun body 32. A gun tube 34 inserts within the gun body 32, and in which the shaped charges 22 are arranged. A detonating cord 36 is routed within the gun body 32 and to each of the shaped charges 22. In the illustrated example, each shaped charge 22 includes a case 38, which is shown having a cup-like shape with a closed end and an open end. A cavity is formed in the case 38 that is accessible through the open end. Further included with this example of the shaped charge 22 is energetic material 40 disposed in the cavity. A frusto-conical liner 41 is inserted into the open end of the case 38 and pressed against the energetic material 40, and with its apex generally coaxial with the case 38 and set against a surface of the energetic material 40 opposite from a lower surface of the cavity. Initiating a detonation in the detonating cord 36 forms a detonation wave in the cord 36, that is passed to each of the shaped charges 22 to initiate detonation of the energetic material 40. Detonation of the energetic material 40 forces the liner 41 from the case 38 at a high rate of speed, and also inverts the liner 41 to form an elongate jet 23 (FIG. 1). Other example shapes of the liner 41 include semi-hemispherical and elongate “V” shaped elements.

Also schematically depicted in FIG. 2 is an example of a detonator 42 for initiating detonation in the detonation cord 36. As shown, the detonator 42 includes a primary explosive 43 set in a housing adjacent a secondary explosive 44. The detonator 42 is shown in communication with the wireline 24, and which in an embodiment selectively transmits an electrical signal to the detonator 42 that is directed to an exploding bridge wire (not shown) disposed in or adjacent to the primary explosive 43. Directing a designated amount of electricity to the exploding bridge wire disintegrates the exploding bridge wire, and generates a release of energy for initiating detonation of the primary explosive 43. In one example, a source of electricity is provided on surface 28, such as in the service truck 26, and which selectively provides electricity to the exploding bridge wire via the wireline 24. In the illustrated embodiment, the primary explosive 43 is more sensitive than the secondary explosive 44. Thus the energy released by disintegrating the exploding bridge wire may be insufficient to initiate detonation in the secondary explosive 44.

In an example, the energetic material 40 is a high explosive that can be exposed to high temperatures over a long period of time and without premature initiation, combustion, or detonation. Moreover, after being exposed to the high temperature for an extended period of time, the energetic material 40 can be initiated to a reaction, wherein an amount of energy released during the reaction is substantially the same as an amount of energy released when exposed to what are considered normal operating temperatures for an energetic material. For the purposes of discussion herein, a high temperature environment for the energetic material is one that is at about 500° F. or greater. Further, in one example an extended period of time being exposed to a high temperature environment includes at least one hour, at least two hours, at least three hours, at least four hours, at least five hours, at least six hours, at least seven hours, at least eight hours, at least nine hours, at least ten hours, at least 100 hours, and all time periods therebetween.

Example materials for the energetic material 40 and secondary explosive 44 include an energetic heterocycle compound, pyrazine compounds, 2,6-diamino-3,5-dinitropyrazine-1-oxide (“LLM-105”), and combinations thereof. Examples exist wherein energetic material 40 made up of all or a part of LLM-105 is subjected to high temperature for an extended period of time (as discussed above), and yet remains detonatable, so that when detonated the energetic material 40 releases and/or generates an amount of energy in the form of a high pressure gas that is substantially the same as that when detonated prior to high temperature exposure, such as normal operating conditions. As discussed in more detail below, the energetic material 40 is not limited to being included in shaped charges 22, but can also be included within the detonating cord 36. Moreover, any tool or operation within a wellbore can include the energetic material 40, for example, actuators for shifting sleeves, release keys, fracture plugs to create dynamic underbalance, downhole shot indicators, setting packers, ignitors (primary and secondary), severing tools, junk shots, chemical cutters, back off tools, and power charges. Embodiments exist where the primary explosive 43 includes silver azide.

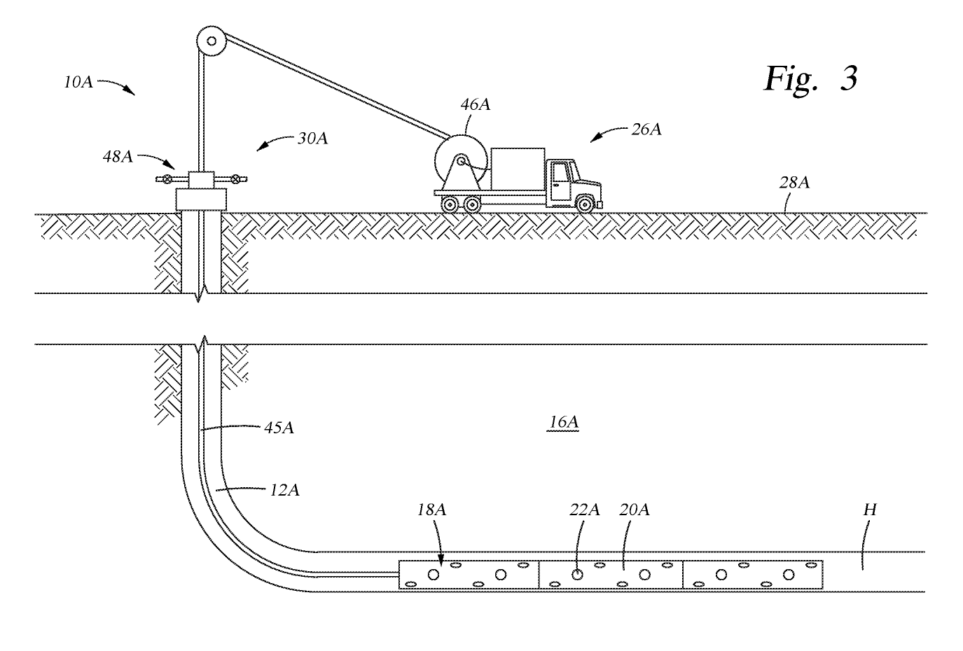

Referring now to FIG. 3, an alternate example of a perforating system 10A is shown in a partial side sectional view disposed in a wellbore 12A. Here wellbore 12A includes a deviated or horizontal section H in which the string 18A of perforating guns 20A is disposed. Further in this example, the perforating string 18A is being deployed on coiled tubing 45A rather than the wireline 24 of FIG. 1. The coiled tubing 45A is spooled from a reel 46A shown mounted on surface truck 26A. The coiled tubing 45A enters the wellbore 12A through wellhead assembly 30A, which in this example includes a blowout preventer 48A. In one non-limiting example of operation, the horizontal section H of the wellbore 12A has a temperature of at least around 500° F. Additionally, due to a sequence of operations in the wellbore 12A, the perforating string 18A remains horizontal section H for an extended period of time and thus in conditions where the temperature is at least around 500° F. In an example, an extended period of time being exposed to a high temperature environment includes at least one hour, at least two hours, at least three hours, at least four hours, at least five hours, at least six hours, at least seven hours, at least eight hours, at least nine hours, at least ten hours, at least 100 hours, and all time periods therebetween.

After being exposed to the high temperature for the extended period of time, the shaped charges 22A in the perforating string 18A are detonated that form perforations (not shown) within the formation 16A adjacent the wellbore 12A. In the example of FIG. 3, energetic material (not shown) disposed within the shaped charges 22A includes LLM-105, thus energy released by LLM-105 detonation is not reduced by the high temperature exposure. As is known, a reduced detonation energy can result in no detonation, or a reduced energy detonation thereby shortening the lengths of perforations 14 (FIG. 1), that in turn diminishes mineral production from the formation 16A.

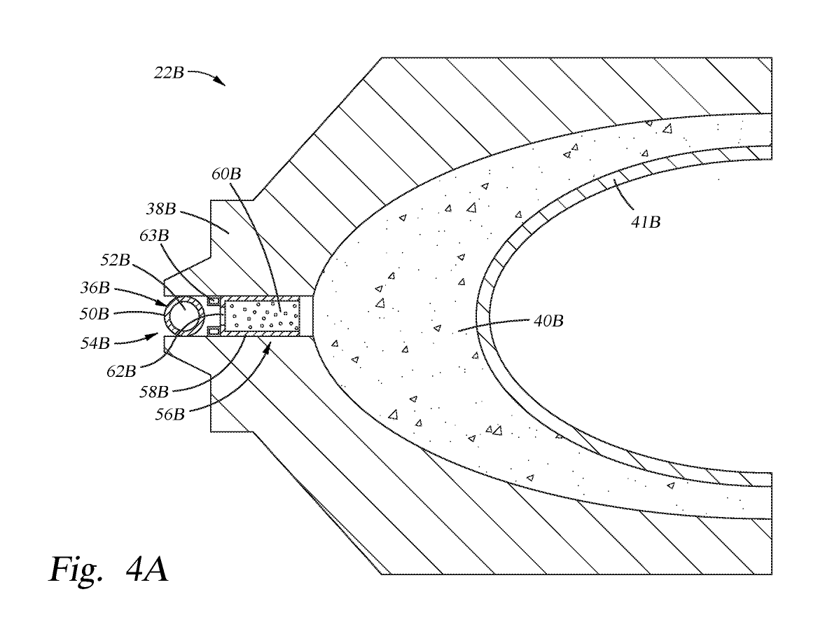

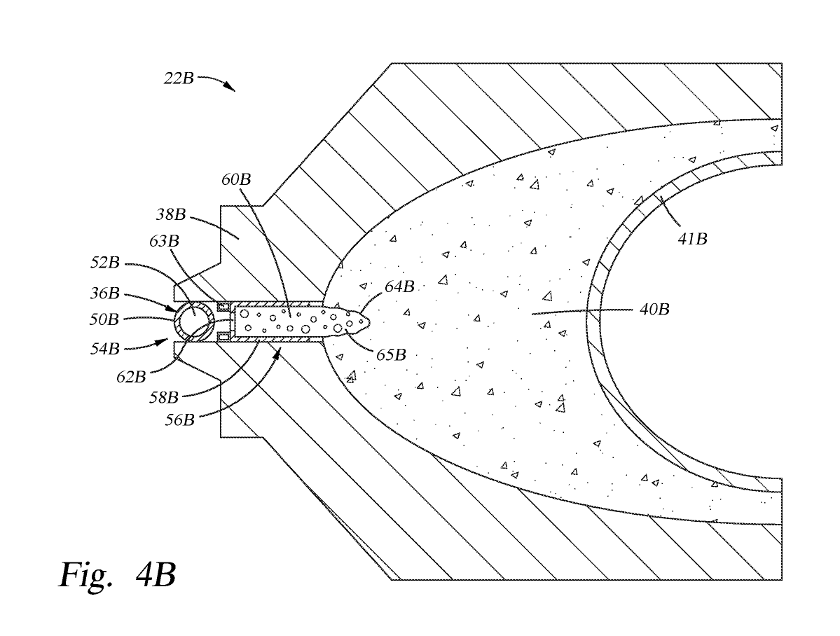

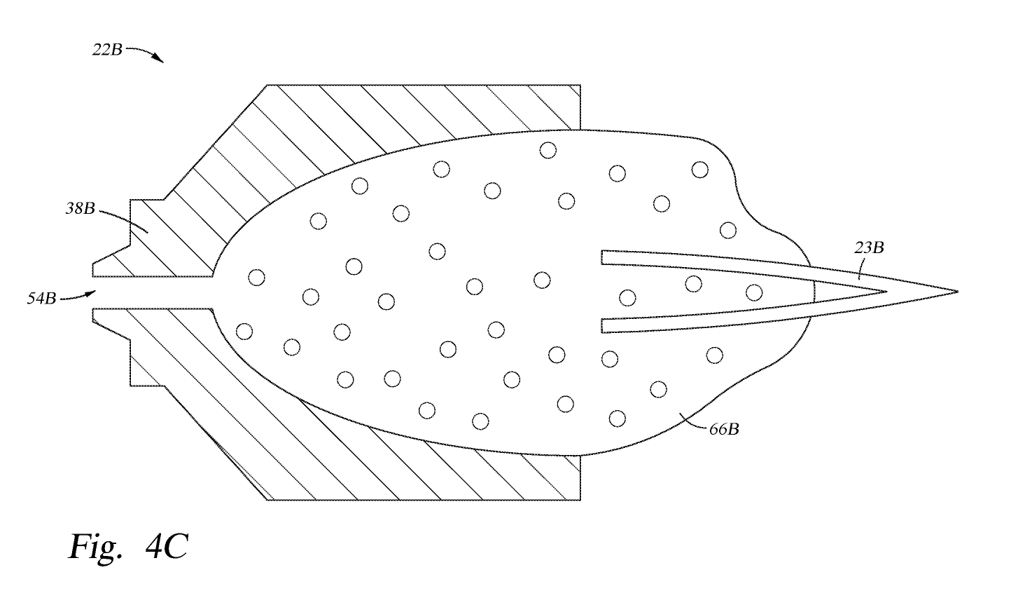

Shown in a side sectional view in FIG. 4A is an example of a shaped charge 22B having energetic material 40B disposed in a housing 38B, and a liner 41B set on the side of the energetic material 40B opposite from the housing 38B. In one embodiment the energetic material 40B includes LLM-105 or is made entirely of LLM-105. Also illustrated in FIG. 4A is a jacket 50B provided on an outer surface of the detonation cord 36B, where example materials of the jacket 50B include aluminum, copper, nickel, lead, magnesium, molybdenum, iron, steel, and alloys and combinations thereof. An energetic material 52B is included within the jacket 50B that when detonated forms a detonation wave (not shown) that travels along the detonation cord 36B and transfers to and initiates detonation of the shaped charge 22B and other shaped charges 22 within the perforating string 18 (FIG. 1). Further shown in the example of FIG. 4A is a bore 54B that extends through the housing 38B at a location proximate the detonation cord 36B. A primer assembly 56B is shown disposed in the bore 54B and between the detonation cord 36C and energetic material 40B. In this example, the primer assembly 56B includes a cup 58B with sidewalls extending axially along an outer circumference of the cup 58B, and a bottom surface spanning the radial distance between terminal ends of the sidewalls. An opening is defined at an axial end of the cup 58B distal from the bottom surface, and which faces the energetic material 40B. Set in the cup 58B is an amount of energetic material 60B that is detonatable when exposed to the detonation wave generated in the detonation cord 36. An aperture 62B is shown formed axially through the bottom surface, and which allows communication between the detonation cord 36B and energetic material 60B in the cup 58B. An optional ledge 63B is provided in the bore 54B for supporting the cup 58B. In an example, one or both of the energetic material 52B and energetic material 60B include LLM-105, or made up entirely of LLM-105.

Shown in side sectional view in FIGS. 4B and 4C are example stages of detonation of the shaped charge 22B of FIG. 4A. As depicted in FIG. 4B, the energetic material 52B of FIG. 4A has been initiated and produces a resulting detonation wave 63B. The combination of the detonation wave 63B from the energetic material 52B and jacket 50B of FIG. 4A generate sufficient energy to initiate detonation of the energetic material 60B within the primer assembly 56B (FIG. 4A). Initiating detonation of the energetic material 60B generates expanding gases 63B that are shown encroaching into the cavity of the charge case 38B and into contact with the energetic material 40B therein. As shown in FIG. 4C, the expanding gases 63B have sufficient energy, either through temperature, pressure, or both, to initiate detonation of the energetic material 40B. Expanding gases 66C are shown formed by detonation of the energetic material 40B, and which contain sufficient energy to expel the liner 41B from the charge case 38B, and also to invert the liner 41B from its configuration of FIG. 4B, thereby forming a metal jet 23B used to form perforations within the formation 16 (FIG. 1).

An advantage of providing LLM-105 in one or both of the energetic material 52B and energetic material 60B, and providing a jacket 50B on the detonating cord 36B, is that an amount of energy of sufficient magnitude is generated to initiate detonation of energetic material 40B, and when the energetic material 40B includes LLM-105. Moreover, as indicated above, because the detonation performance (e.g. release or generation of energy from detonation) of LLM-105 is not deleteriously affected due to exposure to high temperature, the detonating cord 36B, energetic material 40B (main charge), and primer assembly 56B remain detonatable after exposure to high temperature for an extended period of time. Thus the detonating cord 36B, energetic material 40B, and primer assembly 56B have sufficient energy to create detonation of the shaped charge 22B after being exposed to high temperature for an extended period of time.

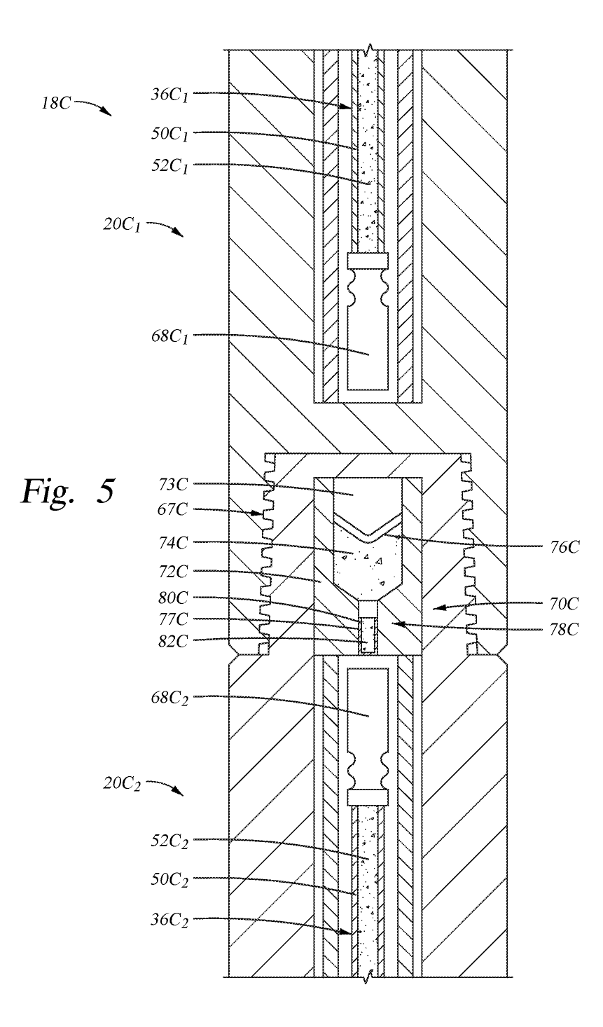

Illustrated in a partial side sectional view in FIG. 5 is an example of an interface between adjacent perforating guns 20C₁, 20C₂ in part of a perforating string 18C. In this example, a threaded connection 67C couples the perforating guns 20C₁, 20C₂ together, the manner of connecting perforating guns 20C₁, 20C₂ is not limited to threads, and other forms of connection though are possible. Sections of detonating cord 36C₁, 36C₂ are further shown set within the adjacent perforating guns 20C₁, 20C₂, and which each include a booster 68C₁, 68C₂ on their respective ends that are proximate one another. Further shown is an example of a booster charge assembly 70C disposed in perforating gun 20C₂ and next to an end of booster 68C₂ opposite from detonation cord 36C₂. As shown, booster charge assembly 70C includes a housing 72C with a cavity 73C, where energetic material 74C and a liner 76C are disposed in the cavity 73C. A bore 77C is shown formed axially in the housing 72C on a side adjacent booster 68C₂. A primer assembly 78C is inserted within bore 77C, and which includes a cup 80C and energetic material 82C in the cup 80C. In an alternative, one or both of the energetic material 74C, 82C includes LLM-105, or are made entirely of LLM-105. In one example of operation of the embodiment of FIG. 5, a detonation wave (not shown) is initiated in detonating cord 36C₂ and which in turn initiates detonation of booster 68C₂. Detonation of booster 68C₂ initiates detonation of energetic material 74C, via primer assembly 70C, that in turn forms a metal jet (not shown) by inverting liner 76C. Metal jet penetrates the bulkheads at the adjacent ends of guns 20C₁, 20C₂, and intersects with booster 68C₁. The energy of metal jet initiates detonation of energetic material (not shown) in booster 68C₁, that then creates a detonation wave in detonation cord 36C₁.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A system for subterranean perforating comprising:
a shaped charge comprising a case, a cavity in the case, and a liner disposed in the cavity;
a primer assembly disposed in a sidewall of the charge case;
a detonation cord disposed adjacent the primer assembly;
an energetic material in the shaped charge, the primer assembly, and the detonation cord, and that comprises 2,6-diamino-3,5-dinitropyrazine-1-oxide; and
a metal jacket encasing the detonation cord.

2. The system of claim 1, further comprising perforating gun bodies that each house additional shaped charges, and booster assemblies within the gun bodies that each include an energetic material that comprises 2,6-diamino-3,5-dinitropyrazine-1-oxide.

3. The system of claim 1, wherein the detonation cord, shaped charge, and primer assembly are detonatable after being disposed at a high temperature for an extended period of time.

4. The system of claim 1, further comprising a detonator coupled with the detonation cord and in communication with a source of electricity, wherein the detonator comprises 6-diamino-3,5-dinitropyrazine-1-oxide.

5. The system of claim 4, wherein the 6-diamino-3,5-dinitropyrazine-1-oxide comprises a secondary explosive, and detonator further comprises a primary explosive that includes silver azide.

6. A method of wellbore operations comprising:
conducting operations within a wellbore using a perforating system that comprises,
a shaped charge,
a detonation cord, and
a pyrazine compound disposed in the shaped charge and detonation cord; and
initiating detonation of the pyrazine compound in the detonation cord that in turn initiates detonation of the pyrazine compound in the shaped charge.

7. The method of claim 6, wherein the pyrazine compound comprises 6-diamino-3,5-dinitropyrazine-1-oxide.

8. The method of claim 6, further comprising deploying the perforating system within a portion of the wellbore that is at a high temperature and for an extended period of time prior to initiating detonation of the pyrazine compound in the detonation cord.

9. The method of claim 8, wherein energy is released from the pyrazine compound during detonation that is at an amount which is substantially the same as energy being released when the pyrazine compound is detonated at a normal operating temperature.

10. The method of claim 6, wherein the detonation cord comprises a metal jacket.

11. A system for subterranean perforating comprising:
a shaped charge;
a detonation cord disposed adjacent the shaped charge; and
an energetic material in the detonation cord, and that comprises an energetic heterocycle compound.

12. The system of claim 11, wherein the energetic heterocycle compound comprises a pyrazine compound.

13. The system of claim 11, wherein the energetic heterocycle compound comprises 2,6-diamino-3,5-dinitropyrazine-1-oxide.

14. The system of claim 11, wherein the shaped charge comprises a charge case with a cavity, a liner in the cavity, and wherein the energetic heterocycle compound is disposed in the cavity between the charge case and the liner.

15. The system of claim 11, wherein the shaped charge further comprises a booster set in the charge case, and wherein an amount of the energetic heterocycle compound is disposed in the booster.
